(19) United States
(12) Patent Application Publication
(10) Pub. No.: US 2024/0187463 A1
(43) Pub. Date: Jun. 6, 2024

(54) MANAGING INKING EVENTS FROM REMOTE INKING DEVICES DURING ONLINE MEETINGS

(71) Applicant: Microsoft Technology Licensing, LLC, Redmond, WA (US)

(72) Inventors: David Claux, Redmond, WA (US); Rahul Kishore Pinjani, Bellevue, WA (US); Siddharth Uppal, Bothell, WA (US)

(73) Assignee: Microsoft Technology Licensing, LLC, Redmond, WA (US)

(21) Appl. No.: 18/060,800

(22) Filed: Dec. 1, 2022

(51) Int. Cl. H04L 65/401; G06F 3/0346; H04L 65/403

(52) U.S. Cl. CPC H04L 65/4015; G06F 3/0346; H04L 65/403

(57) ABSTRACT

Techniques are described for managing inking events from remote inking devices during online meetings. For example, a remote inking device comprising a physical orientation sensor can be used during an online meeting to perform inking actions while shared screen content is being presented during the online meeting. To control the inking action, a stream of coordinate update events can be received from the remote inking device. The stream of coordinate update events represents physical movement of the remote inking device as indicated by the physical orientation sensor. The coordinate update events can be relayed to participant devices of the online meeting. The participant devices can then perform the inking action on local displays.

### BACKGROUND

Consider a presentation at a conference that utilizes an online meeting service with both physical attendees and remote (online) attendees. In the room where the physical attendees are gathered, the presenter stands in front of a large screen presenting content that is shared from a laptop. The remote attendees see the shared content on their computing devices, but do not see the presenter. The presenter uses a physical laser pointer to point directly to the large screen to indicate specific items of displayed content. While the physical attendees in the room will see the laser pointer, the remote attendees will not.

Some existing online meeting solutions provide a laser pointer tool that can be controlled by the presenter using an input device such as a mouse. Using this existing solution, the presenter could sit at the laptop and control a laser pointer tool that would be viewable to the physical attendees and the remote attendees of the presentation. However, such an existing solution limits the ability of the presenter to interact during the presentation. For example, the presenter may have to sit next to their laptop and look at the laptop screen instead of standing in front of, and interacting with, the attendees.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are described for managing inking events during an online meeting, where inking events are events controlling digital inking activity during the online meeting, where the online meeting has a plurality of participant devices, and where shared screen content is being presented during the online meeting. For example, operations can be performed for receiving an indication that a mobile computing device has joined the online meeting as a remote inking device. The operations can further comprise receiving, from the remote inking device, a stream of coordinate update events for performing an inking action during the online meeting, where the inking action draws digital ink on the shared screen content, and where the stream of coordinate update events represents physical movement of the remote inking device as indicated by a physical orientation sensor of the remote inking device. The operations can further comprise, for each of the plurality of participant devices, relaying the stream of coordinate update events to the participant device, where the relayed stream of coordinate update events is usable at the participant device to perform the inking action on a local display of the participant device.

As another example, technologies are described for managing inking events during an online meeting, where inking events are events controlling digital inking activity during the online meeting, where the online meeting has a plurality of participant devices, and where shared screen content is being presented during the online meeting. For example, operations can be performed for receiving, from a remote inking device, a begin inking event message for the online meeting. The operations can further comprise receiving, from the remote inking device, a stream of coordinate update events for performing an inking action, where the inking action draws digital ink on the shared screen content, and where the stream of coordinate update events represents physical movement of the remote inking device as indicated by a physical orientation sensor (e.g., a gyroscope) of the remote inking device. The operations can further comprise, for each of the plurality of participant devices: relaying the begin inking event message to the participant device, and relaying the stream of coordinate update events to the participant device, where the relayed stream of coordinate update events is usable at the participant device to perform the inking action on a local display of the participant device.

### BRIEF DESCRIPTION OF THE DRAWINGS

FIG. 1) is a block diagram depicting example environment for managing inking events from remote inking devices during online meetings.

FIG. 2) is a diagram depicting an example environment comprising a remote inking device that operates as a virtual laser pointer during online meetings.

FIG. 3) is a flowchart of an example method for managing inking events from remote inking devices during online meetings.

FIG. 4) is a flowchart of an example method for managing inking events, including begin inking events and coordinate update events, from remote inking devices during online meetings.

FIG. 5) is a diagram of an example computing system in which some described embodiments can be implemented.

FIG. 6) is an example cloud-support environment that can be used in conjunction with the technologies described herein.

### DETAILED DESCRIPTION

### Overview

The following description is directed to technologies for managing inking events from remote inking devices during online meetings. For example, a remote inking device comprising a physical orientation sensor can be used during an online meeting to perform inking actions while shared screen content is being presented during the online meeting. To control the inking action, a stream of coordinate update events can be received (e.g., by an online meeting service) from the remote inking device. The stream of coordinate update events represents physical movement of the remote inking device as indicated by the physical orientation sensor (e.g., a gyroscope and/or accelerometer). The coordinate update events can be relayed to participant devices of the online meeting. The participant devices can then perform the inking action on local displays.

Presenting shared screen content during an online meeting can present a number of challenges when the online meeting involves remote participants. For example, a presenter may be presenting during an online meeting in front of physical attendees (e.g., standing in front of a large screen presenting shared screen content) as well as remote attendees (e.g., who view the shared screen content on their phones, laptops, desktop computers, or other computing devices). The remote attendees see the shared content on their computing devices, but do not see the presenter or the actions that the presenter is performing. As a specific example, if the presenter uses a physical laser pointer to point directly to the large screen to indicate specific items of displayed content, the physical attendees will see the laser pointer, but the remote attendees will not.

The technologies described herein provide various advantages to presenting shared screen content during online meetings. For example, a presenter can use a remote inking device, such as the presenter's mobile phone, to control a virtual laser pointer on a physical display during an online meeting. Control of the virtual laser pointer is performed by the presenter physically moving the remote inking device, which is translated into coordinates using the physical orientation sensor (e.g., gyroscope) of the remote inking device. The coordinates are communicated directly from the remote inking device to the online meeting service (e.g., via coordinate update events). The online meeting service then communicates the coordinates (e.g., as coordinate update events) to the participants of the online meeting. In this way, the participants of the online meeting (including the remote participants) will see the virtual laser pointer on their displays and the virtual laser pointer will move in correspondence with the presenter's movement of the remote inking device.

In general, the technologies described herein can be used to improve the online meeting experience by allowing a participant (e.g., a presenter) to control an inking action using the participant's remote inking device (e.g., the participant's mobile phone or other mobile computing device). For example, instead of the participant having to use a mouse or other input device to control an inking tool, such as a laser pointer, the participant can use their remote inking device to perform inking actions, such as using their remote inking device as a virtual laser pointer that is viewable by all participants (e.g., local and remote participants) of the online meeting. This solution allows a participant greater flexibility when participating in an online meeting. For example, a presenter that is standing in front of a large screen can use a mobile phone to control a virtual laser pointer that is then displayed on the large screen and on all participant's local displays. The presenter is not tethered to the computer that is presenting the shared screen content (e.g., by having to use a mouse), and instead the presenter can walk around and present in a more natural way (e.g., interact with a physical audience during the presentation) while still controlling the virtual laser pointer that is displayed on the local large screen as well as all remote participants' local displays.

According to a first example advantage and improvement, the technologies described herein allow a remote inking device to initiate an inking action (e.g., a virtual laser pointer) that is then relayed by an online meeting service to each participant device. Each participant device then performs the inking action locally (e.g., by drawing a virtual laser pointer on a local display). For example, the remote inking device can send inking events, such as coordinate update events, to the online meeting service during an online meeting in which shared screen content is being presented. The online meeting service can relay the inking events (e.g., the coordinate update events) to each participant device. Each participant device can receive the inking events and carry out the inking action.

According to a second example advantage and improvement, the technologies described herein allow multiple inking actions to be performed simultaneously by multiple corresponding remote inking devices during an online meeting by using unique inking event identifiers. For example, each inking action can be associated with its own unique inking event identifiers (e.g., each event of the inking action can comprise the unique inking event identifier associated with the inking action). An online meeting service can receive events for the multiple inking actions and relay them to each participant device. Each participant device can then perform the multiple inking actions.

### Terminology

The term “online meeting” refers to a meeting between a plurality of participant devices over a computer network (e.g., comprising the Internet). The participant devices can be any type of computing device capable of participating in an online meeting (e.g., running online meeting software), such as a mobile phone, a laptop or desktop computer, a tablet, or another type of computing device. Online meetings are managed by online meeting services (e.g., a collection of computing resources, such as servers or cloud resources, that manage the online meeting for the participants). One example of an online meeting service is Microsoft Teams®.

The term “inking event” refers to an event associated with performing a digital inking action for an online meeting. One type of inking event is a coordinate update event in which updated coordinates (e.g., x and y coordinates or another type of coordinates such as coordinates in three-dimensional space) are communicated (e.g., sent to an online meeting service and/or received from an online meeting service). Other examples of inking events include begin inking events and end inking events.

The term “inking action” refers to an action of drawing digital ink on shared screen content using a remote inking device. One type of inking action is the control of a virtual laser pointer which draws a graphical laser pointer indicator (e.g., a colored dot) on shared computer display content (also called shared screen content) of the online meeting. Another type of inking action is drawing of shapes (e.g., lines, arrows, circles, boxes, and/or other types of shapes) on shared computer display content of the online meeting. Inking actions are controlled using inking events.

The term “shared screen content” refers computer display content (e.g., graphics, text, video, etc.) that is shared by a participant device of an online meeting. The shared screen content could be an entire computer display, a specific window (e.g., a specific application window), a presentation, a digital whiteboard, etc.

The term “remote inking device” refers to a mobile computing device that comprises a physical orientation sensor (e.g., gyroscope and/or accelerometer) and that is used for performing inking actions during an online meeting. The remote inking device performs the inking actions based on physical movement of the remote inking device as indicated by the physical orientation sensor. The remote inking device is an independent mobile computing device that communicates with an online meeting service via one or more network protocols. One example of a remote inking device is a mobile phone.

### Managing Inking Events

In the technologies described herein, inking events can be managed during online meetings. For example, an online meeting service can send and receive inking events during an online meeting. The inking events can include events to begin an inking action (e.g., a begin stroke event or begin inking event), events to update coordinates (e.g., an add point to stroke event or a coordinate update event), events to end an inking action (e.g., an end stroke event or end inking event), and/or other types of events.

One type of inking event is a coordinate update event in which updated coordinates (e.g., x and y coordinate values or another type of coordinate values such as coordinates in three-dimensional space) are communicated (e.g., sent to an online meeting service and/or received from the online meeting service). Coordinate update events are received from a remote inking device based on data obtained from a physical orientation sensor of the remote inking device. In some implementations, the physical orientation sensor is a gyroscope or comprises a gyroscope. In some implementations, the physical orientation sensor is an accelerometer or comprises an accelerometer. In some implementations, the physical position sensor refers to a combination of sensor technology that comprises a gyroscope and an accelerometer.

In some implementations, a coordinate update event comprises two-dimensional x and y coordinate values resulting from physical movement of the remote inking device. For example, yaw and pitch data are obtained from the physical orientation sensor (e.g., the gyroscope) of the remote inking device. The pitch and yaw data are translated into corresponding x (horizontal) and y (vertical) coordinates. The coordinates are communicated, via coordinate update events, to the online meeting service. In some implementations, three-dimensional coordinates are derived from the data obtained from the physical orientation sensor (e.g., the gyroscope) and communicated via coordinate update events.

Another type of inking event is a begin inking event. The begin inking event can be initiated at the start of an inking action (e.g., when a mobile device is activated for use as a virtual laser pointer). For example, when a user activates a mobile phone to act as a virtual laser pointer during an online meeting, the mobile phone can send a begin inking event message to the online meeting service that is managing the online meeting. The begin inking event can be initiated in a variety of ways, such as by the user selecting a user interface element (e.g., touching a button on the screen) to initiate use of the user's mobile phone as a remote inking device. For example, the user could be logged into online meeting software on the user's phone that includes a user interface element for using the user's phone as a remote inking device. As another example, the remote inking device could display a notification prompting the user to activate a remote inking mode where the computing device (e.g., the user's phone) acts as a remote inking device during the online meeting. The notification can be automatically displayed upon detecting that the user that is logged in to the remote inking device is a participant in an online meeting (e.g., by using user account identifiers). For example, a selectable user interface element with a message such as, “Use as a laser pointer remote in meeting <name of meeting>,” could be displayed. In some implementations, the remote inking device is added as a “participant” of the online meeting for the purpose of communicating with the online meeting service, including sending the remote inking events to the online meeting service. For example, the inking events can comprise a unique session identifier that identifies the specific online meeting that the remote inking device is a participant of.

Another type of inking event is an end inking event. The end inking event can be sent to end an inking action. For example, when a user stops using a mobile phone as a virtual laser pointer during an online meeting, the mobile phone can send an end inking event message to the online meeting service that is managing the online meeting.

In some implementations, an inking event or inking action is associated with an inking tool type. The inking tool type indicates which inking tool is to be used when performing the inking action. Example inking tools include a virtual laser pointer, a line drawing tool (e.g., for drawing lines or arrows), a shape drawing tool (e.g., for drawing shapes such as circles or rectangles), a highlighter tool, and an eraser tool. The inking tool type can also indicate properties of the inking tool (e.g., brush or pencil properties, size, color, shape, etc.). For example, a begin inking event can comprise an inking tool type indicating that the inking tool is a virtual laser pointer that draws a red dot.

In some implementations, an inking event can be associated with a property indicating whether the pointer is down. When the pointer is down (e.g., when the pointer down property is set to true), then the inking action will be performed. For example, if a user is going to draw an arrow on shared screen content during an online meeting, the user can move a pointer to a starting location using a remote inking device (e.g., which generates coordinate update events). The user can then activate a drawing property of the inking action (e.g., by tapping or holding down on the display of the remote inking device or selecting a user interface element, which sends an event indicating the pointer is down) and move the remote inking device to draw the line (e.g., generating a stream of coordinate update events according to the movement of the remote inking device as indicated by the physical orientation sensor). The user can deactivate the drawing property of the inking action (e.g., by releasing the touch action, which sends an event indicating the pointer is up).

In some implementations, each inking event is associated with an indication of whether the pointer is down. For example, each inking even can have a pointer down property that is set to true when the pointer is down and false when the pointer is up.

In some implementations, an inking action is associated with a unique inking event identifier. The unique inking event identifier allows the inking action, and its associated inking events, to be uniquely identified. For example, when an inking action is initiated, it can be assigned a unique inking event identifier. The assigned unique inking event identifier can then be used for all the inking events used to perform the inking action (e.g., begin inking events, coordinate update events, end inking events, and/or other inking events associated with the inking action). For example, when each of the inking events is communicated, the inking event can comprise the unique inking event identifier. Using unique inking event identifiers, the online meeting service, and the participant devices, can distinguish between different inking actions that are being performed for a given online meeting.

In some implementations, multiple inking actions are supported (e.g., at separate times and/or simultaneously during an online meeting). For example, a first user associated with a first participant device could perform a first inking action using a first remote inking device (e.g., the first user's mobile phone). The first inking action is associated with a first unique inking event identifier. A second user associated with a second participant device could perform a second inking action using a second remote inking device (e.g., the second user's mobile phone). The second inking action is associated with a second unique inking event identifier. Both users can be participants of the same online meeting. Because each inking action is associated with its own unique inking event identifier, both inking actions can be performed at the same time. For example, the first and second inking actions can be performed at the same time on screen content being shared during the online meeting (e.g., the first inking action could be a virtual laser pointer and the second inking action could be an inking action that draws lines or arrows). In this way, two or more inking actions can be supported (e.g., at separate times and/or simultaneously during an online meeting) during the same online meeting.

In a particular implementation, the following events are used to perform the inking actions using remote inking devices:

Begin stroke event. This event begins an inking action at a particular x and y coordinate location. This event also indicates the inking tool being used (e.g., laser pointer or other inking tool) and a unique inking event identifier for the inking action.

Add point to stroke event. This event adds a point (a particular x and y coordinate location) to the stroke. This event also comprises a unique inking event identifier to associate it with a particular inking action. For example, if the user is using a remote inking device (e.g., the user's phone) to control a virtual laser pointer, then movement of the remote inking device will generate add point to stroke events to move the virtual laser pointer.

End stroke event. This event ends an inking action. This event also comprises a unique inking event identifier for the inking action being ended.

Each of the events in this implementation can also include an indication of whether the pointer is up or down.

Environments for Managing Inking Events during Online Meetings

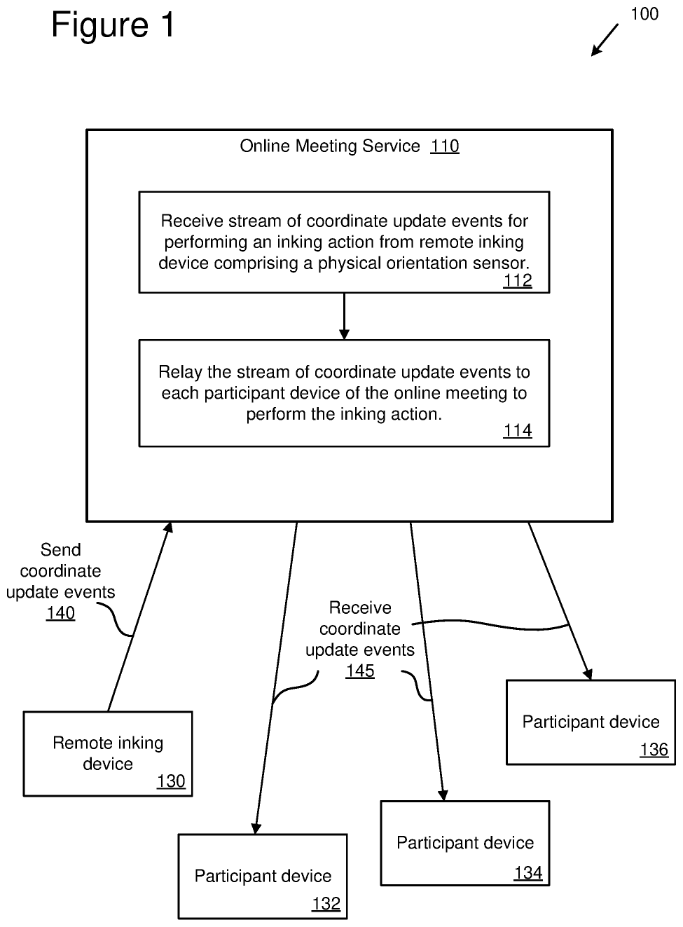

FIG. 1 is a diagram depicting example environment 100 for managing inking events from remote inking devices during online meetings. The example environment 100 includes an online meeting service 110. The online meeting service 110 manages online meetings for various participant devices, such as participant devices 132, 134, and 136. The online meeting service 110 can be implemented using various hardware and/or software resources (e.g., computer servers, cloud computing resources, online meeting software, etc.).

The online meeting service 110 performs operations for managing the inking events that are performed during online meetings. For example, during an online meeting, the online meeting service 110 could receive inking events including begin inking events, coordinate update events, end inking events, and/or other types of inking events. The online meeting service 110 relays (e.g., broadcasts) the received inking events to the participants (e.g., to each participant device) of the online meeting.

As depicted in the example environment 100, the online meeting service 110 is managing inking events during an online meeting among three participant devices, participant device 132, participant device 134, and participant device 136. There is also a remote inking device, remote inking device 130, that is associated with the online meeting. For example, a user of one of the participant devices, such as participant device 132, could be using remote inking device 130 (e.g., the user's mobile phone) to perform inking actions during the online meeting.

Remote inking device 130 comprises a physical orientation sensor (e.g., a gyroscope, an accelerometer, and/or other physical orientation sensors). While the remote inking device 130 is being used to perform an inking action (e.g., as activated by the user of remote inking device 130), remote inking device 130 sends coordinate update events to the online meeting service 110, as depicted at 140. The coordinate update events are generated by the remote inking device 130 and reflect physical movement of the remote inking device 130. The coordinate update events are sent as a sequence or stream of events (e.g., on a periodic basis, such as a number of times per second) to the online meeting service 110.

The online meeting service 110 receives the stream of coordinate update events from the remote inking device 130, as depicted at 112. In response, the online meeting service 110 relays the stream of coordinate update events to each of the participant devices, as depicted at 114. Each participant device receives the coordinate update events, as depicted at 145, and performs the corresponding inking action.

For example, if the inking action is a virtual laser pointer, the remote inking device 130 is used to control movement of the virtual laser pointer through physical movement of the remote inking device 130 (e.g., yaw and pitch movements, which are translated into x and y coordinate update events). The remote inking device 130 sends a stream of coordinate update events representing movement of the virtual laser pointer to the online streaming service 110, which relays the stream of coordinate update events to the participant devices 132, 134, and 136. The participant devices 132, 134, and 136, upon receiving the stream of coordinate update events, depict the virtual laser pointer on shared screen content of the online meeting being displayed at each respective participant device.

The remote inking device 130 can perform various optimizations when generating or sending inking events to the online meeting service 110. For example, the remote inking device 130 can change the sampling rate (e.g., increase or reduce the sampling rate depending on the desired resolution, available processing power, available bandwidth, and/or based on other criteria), reduce the frequency of events (e.g., by removing redundant coordinate updates), batch events (e.g., to reduce the number of update messages sent to the online meeting service 110), and/or perform other optimizations.

In some implementations, for the inking action to be accurately depicted on the shared screen content, the remote inking device needs to know the workspace dimensions of the shared screen content. Using the workspace dimensions, the remote inking device can limit the coordinates it sends (e.g., in coordinate update events) to conform to the dimensions. For example, if the if the workspace dimensions are 250 wide by 150 high, then the remote inking device can limit its coordinates to that range. In some implementations, if the remote inking device moves beyond the range limit at a particular edge (e.g., past the right edge of the workspace dimensions), the limit edge is moved accordingly, so that when the remote inking device beings moving back, drawing will start immediately.

In some implementations, the online meeting service (e.g., online meeting service 110) obtains the workspace dimensions from the participant device that is sharing the screen content (e.g., from participant device 132). The participant device that is sharing the screen content can obtain the workspace dimensions from the content that is being shared (e.g., if the shared content is an application window, then the workspace dimensions are the dimensions of the window, if the shared content is an entire display then the workspace dimensions are the dimensions of the display, and so on). For example, the online meeting service can send a request to the participant device, which in turn sends a response to the online meeting service with the workspace dimensions (e.g., where the request and response comprise the unique session identifier of the online meeting). The online meeting service then sends the workspace dimensions to the remote inking device (e.g., to remote inking device 130) when the remote inking device beings an inking action (e.g., upon receiving a being inking event from the remote inking device). For example, the online meeting service knows that there is a remote inking device when the remote inking device connects to the online meeting (e.g., using a unique session identifier of the online meeting) and/or the remote inking device sends a begin inking event. The remote inking device then uses the workspace dimensions to establish a boundary for the stream of coordinate update events (e.g., to limit the x and y coordinates based on the workspace dimensions).

In some implementations, when a virtual laser pointer is activated during an online meeting, all of the participant devices of the online meeting enter a laser pointer mode. During the laser pointer mode, the shared screen content being presented is screen captured. For example, the shared screen content that is being presented is captured and sent to the online meeting service where it is distributed to the participant devices for display. In this way, all of the participant devices will see the shared screen content with the same dimensions (the workspace dimensions corresponding to the shared screen content) and the virtual laser pointer position (as controlled by the coordinate update events) will match among the participant devices (e.g., specific x and y coordinates will be at the same location across the shared screen content displayed at the participant devices).

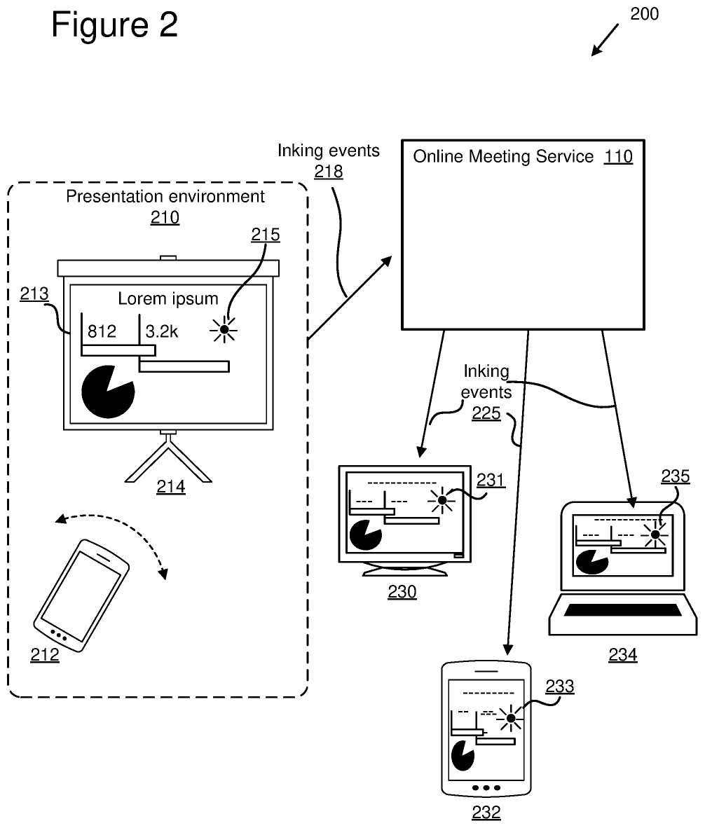

FIG. 2 is a diagram depicting example environment 200 comprising a remote inking device 212 that operates as a virtual laser pointer during online meetings. The remote inking device 212 is part of a presentation environment 210 in which an online meeting is occurring. The presentation environment 210 represents a physical location (e.g., an office or conference room) in which a user is viewing shared screen content 213 on a display 214 (e.g., computer monitor, smart television, or projector screen). The presentation environment 210 can also comprise one or more local participants (e.g., people which are physically present to view the shared screen content 213 on the display 214 and which may also have participant devices that are connected to the online meeting).

The remote inking device 212, which comprises a gyroscope in this example scenario, is being used by a user to control movement of a virtual laser pointer 215 during the online meeting. Specifically, physical movement of the remote inking device 212 controls movement of the virtual laser pointer 215, which is represented graphically by the virtual laser pointer 215 “dot” displayed on the display 214 as part of the shared screen content 213.

While the remote inking device 212 is performing the inking action (in this scenario, controlling the virtual laser pointer 215), the remote inking device 212 sends inking events to the online meeting service 110, as depicted at 218. The inking events comprise coordinate update events representing physical movement of the remote inking device 212 (e.g., coordinate updates comprising x and y values).

The online meeting service 110 receives the inking events and relays the events to the other participants of the online meeting. In this scenario, the online meeting service 110 is relaying the inking events to participant device 230 (e.g., a desktop computer), participant device 232 (e.g., a tablet), and participant device 234 (e.g., a laptop computer), as depicted at 225. Participant devices 230, 232, and 234, upon receiving the inking events (which in this scenario include the coordinate update events), display the virtual laser pointer on the shared screen content, as depicted on each of the displays of participant devices 230, 232, and 234. Specifically, participant device 230 displays virtual laser pointer 231, participant device 232 displays virtual laser pointer 233, participant device 234 displays virtual laser pointer 235. The online meeting service 110 also relays the events to the participant device in the presentation environment 210, which is associated with display 214 (e.g., a smart television or computing device operating a projector), so that display 214 also displays the shared screen content 213 with the virtual laser pointer 215.

The online meeting service 110 supports remote inking devices in addition to remote inking device 212. For example, the user of participant device 230 could also use a remote inking device (e.g., the user's mobile phone) to perform a second inking action (e.g., a second virtual laser pointer or another type of inking tool). To initiate use of the additional remote inking device during the online meeting, the user could select a user interface element on the remote inking device (e.g., as a result of being logged in to an online meeting application) or respond to a notification on the remote inking device (e.g., as a result of the user picking up the user's mobile phone during the online meeting). The online meeting service 110 can be notified that the additional remote inking device is being used by receiving a message (e.g., a being inking event message), which can include: a unique device identifier for the additional remote inking device, a unique inking event identifier for the additional inking action, and/or a unique session identifier for the online meeting. In response, the online meeting service 110 can send workspace dimensions to the additional remote inking device. The additional remote inking device would then send its inking events (comprising coordinate update events) to the online meeting service 110, which would in turn relay those inking events to the other participants where the inking action would be performed. In this way, both inking actions (from remote inking device 212 and the additional remote inking device) would be performed on the shared screen content 213. For example, the inking actions could be distinguished by having different properties, such as different color, size, shape, labels, etc. (e.g., one virtual laser pointer could be red and the other green). In general, the online meeting service 110 can manage multiple inking actions from multiple corresponding inking devices (e.g., simultaneously) based on each inking action's unique inking event identifier.

Methods for Managing Inking Events during Online Meetings

In any of the examples herein, methods can be provided for managing inking events from remote inking devices during online meetings. The methods can be performed by an online meeting service that receives inking events and relays the received inking events to participant devices of the online meeting.

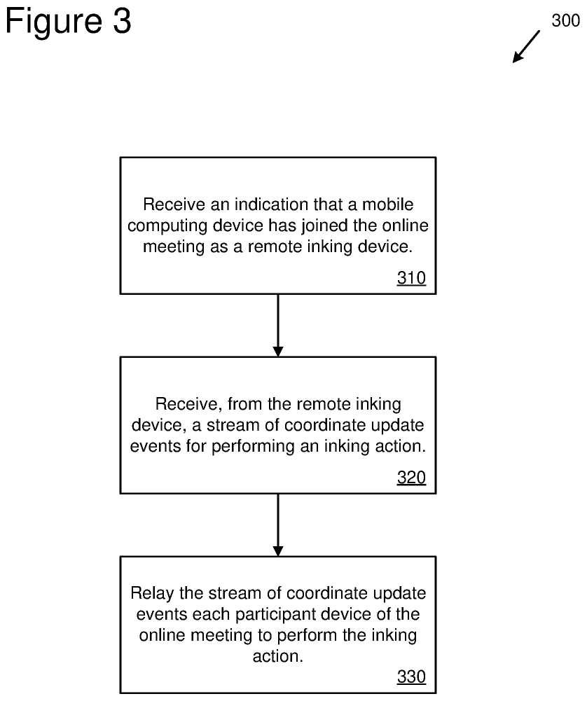

FIG. 3 is a is a flowchart of an example method 300 for managing inking events from remote inking devices during online meetings. For example, the example method 300 can be performed by an online meeting service, such as online meeting service 110.

At 310, an indication is received that a mobile computing device has joined the online meeting as a remote inking device. In some implementations, the indication comprises a begin inking event message. For example, a user of the mobile computing device (e.g., the user's mobile phone) can join the online meeting (e.g., using an online meeting app) and indicate that the mobile computing device will be used as a remote inking device during the online meeting (e.g., by selecting a user interface element or responding to a notification). The remote inking device can then send the indication (e.g., the begin inking event message or another type of message that indicates the mobile computing device will be used as a remote inking device) to the online meeting service.

At 320, a stream of coordinate update events is received from the remote inking device. The remote inking device comprises a physical orientation sensor (e.g., a gyroscope and/or accelerometer). The stream of coordinate update events represents physical movement of the remote inking device as indicated by the physical orientation sensor. The stream of coordinate update events is for performing an inking action during an online meeting.

At 330, the stream of coordinate update events is relayed to each of the participant devices of the online meeting. The relayed stream of coordinate update events is usable at each participant device to perform the inking action on a local display of the participant device. For example, each of the participant devices performs the inking action on its respective local display according to the relayed stream of coordinate update events.

The example method 300 is performed while shared screen content is being presented during the online meeting. For example, one of the participant devices can be sharing screen content (e.g., a desktop, an application window, etc.) during the online meeting, and the inking action (e.g., a virtual laser pointer or other type of inking action) can be performed by drawing on the shared screen content (e.g., compositing a graphical representation of a virtual laser pointer).

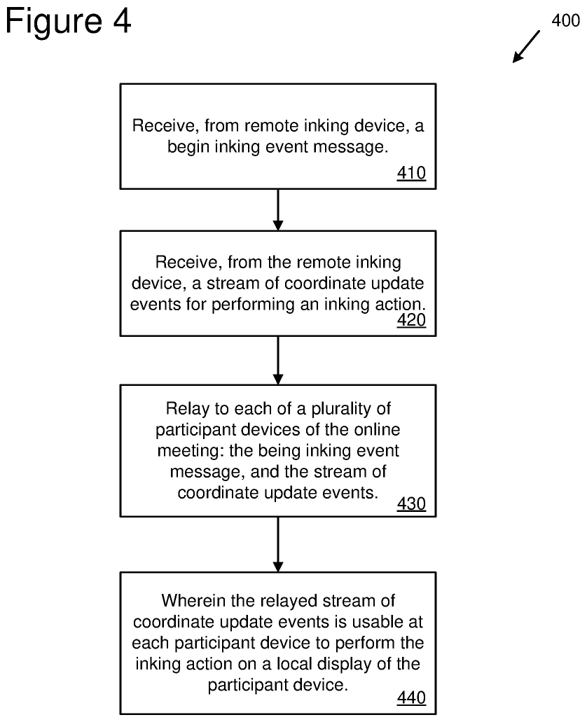

FIG. 4 is a is a flowchart of an example method 400 for managing inking events, including begin inking events and coordinate update events, from remote inking devices during online meetings. For example, the example method 400 can be performed by an online meeting service, such as online meeting service 110.

At 410, a begin inking event message is received from a remote inking device. The remote inking device is associated with the online meeting. For example, the begin inking event message can comprise a unique session identifier that identifies the online meeting.

At 420, a stream of coordinate update events is received from the remote inking device. The remote inking device comprises a physical orientation sensor (e.g., gyroscope and/or accelerometer), and the stream of coordinate update events represent physical movement of the remote inking device as indicated by the physical orientation sensor. The stream of coordinate update events is for performing an inking action during the online meeting.

At 430, the begin inking event message and the coordinate update events are relayed to each of the plurality of participant devices of the online meeting. At 440, the relayed stream of coordinate update events is usable at each participant device to perform the inking action on a local display of the participant device. For example, each of the participant devices performs the inking action on its respective local display according to the relayed stream of coordinate update events.

### Additional Examples

Example 1 is a computing device configured to operate as an online meeting service and perform operations for managing inking events during an online meeting, wherein inking events are events controlling digital inking activity during the online meeting, wherein the online meeting has a plurality of participant devices, and wherein shared screen content is being presented during the online meeting, the computing device comprising: a processor; a network interface; and memory; the computing device configured to perform operations for managing the inking events during the online meeting, the operations comprising: receiving an indication that a mobile computing device has joined the online meeting as a remote inking device; receiving, from the remote inking device, a stream of coordinate update events for performing an inking action during the online meeting, wherein the inking action draws digital ink on the shared screen content, and wherein the stream of coordinate update events represents physical movement of the remote inking device as indicated by a physical orientation sensor of the remote inking device; and for each of the plurality of participant devices: relaying the stream of coordinate update events to the participant device; wherein the relayed stream of coordinate update events is usable at the participant device to perform the inking action on a local display of the participant device.

Example 2 includes the subject matter of Example 1, and further specifies that the operations further comprise: prior to receiving the stream of coordinate update events, receiving, from the remote inking device, a begin inking event message, wherein the begin inking event message comprises an indication of an inking tool type, and wherein the inking action is performed using the inking tool type.

Example 3 includes the subject matter of any of Examples 1-2, and further specifies that the remote inking device operates as a virtual laser pointer device as indicated by an inking tool type.

Example 4 includes the subject matter of any of Examples 1-3, and further specifies that an inking tool type supports a plurality of different inking tools, comprising a virtual laser pointer, a line drawing tool, and a highlighter tool.

Example 5 includes the subject matter of any of Examples 1-4, and further specifies that the physical orientation sensor comprises a gyroscope, and wherein the stream of coordinate update events comprises x and y coordinate values that are translated from yaw and pitch data obtained from the gyroscope of the remote inking device.

Example 6 includes the subject matter of any of Examples 1-5, and further specifies that the operations further comprise: receiving, from the remote inking device, a pointer down event; and for each of the plurality of participant devices: relaying the pointer down event to the participant device, wherein the pointer down event activates a drawing property of the inking action.

Example 7 includes the subject matter of any of Examples 1-6, and further specifies that receiving the indication that the mobile computing device has joined the online meeting as a remote inking device comprises: receiving, from the remote inking device, a begin inking event message; wherein the begin inking event message is associated with a unique inking event identifier, and wherein the stream of coordinate update events is associated with the unique inking event identifier.

Example 8 includes the subject matter of any of Examples 1-7, and further specifies that the operations further comprise: receiving, from a second remote inking device, a second stream of coordinate update events for performing a second inking action, and wherein the second stream of coordinate update events represents physical movement of the second remote inking device as indicated by a physical orientation sensor of the second remote inking device; and for each of the plurality of participant devices: relaying the second stream of coordinate update events to the participant device; wherein the relayed second stream of coordinate update events is usable at the participant device to perform the second inking action on a local display of the participant device; wherein the first inking action is associated with a first unique inking event identifier and the second inking action is associated with a second unique inking event identifier which allows simultaneous display of both the inking action and the second inking action on the local displays of the plurality of participant devices.

Example 9 includes the subject matter of any of Examples 1-8, and further specifies that the operations further comprise: receiving, from a participant device presenting the shared screen content, an indication of workspace dimensions of the shared screen content; and sending, to the remote inking device, the indication of the workspace dimensions of the shared screen content, wherein the indication of the workspace dimensions of the shared screen content is usable by the remote inking device to establish a boundary for the stream of coordinate update events.

Example 10 is a method, implemented by a computing device, for managing inking events during an online meeting, wherein inking events are events controlling digital inking activity during the online meeting, wherein the online meeting has a plurality of participant devices, and wherein shared screen content is being presented during the online meeting, the method comprising: receiving, from a remote inking device, a begin inking event message for the online meeting; receiving, from the remote inking device, a stream of coordinate update events for performing an inking action, wherein the inking action draws digital ink on the shared screen content, and wherein the stream of coordinate update events represents physical movement of the remote inking device as indicated by a physical orientation sensor of the remote inking device; and for each of the plurality of participant devices: relaying the begin inking event message to the participant device; and relaying the stream of coordinate update events to the participant device; wherein the relayed stream of coordinate update events is usable at the participant device to perform the inking action on a local display of the participant device.

Example 11 includes the subject matter of Example 10, and further specifies that the remote inking device operates as a virtual laser pointer device, wherein the inking action is a virtual laser pointer, and wherein the relayed stream of coordinate update events is usable at each of the plurality of participant devices to display the virtual laser pointer on its respective local display.

Example 12 includes the subject matter of any of Examples 10-11, and further specifies that the physical orientation sensor comprises a gyroscope, and wherein the stream of coordinate update events comprises x and y coordinate values that are translated from yaw and pitch data obtained from the gyroscope of the remote inking device.

Example 13 includes the subject matter of any of Examples 10-12, and further specifies that the method further comprises: receiving, from the remote inking device, a pointer down event; and for each of the plurality of participant devices: relaying the pointer down event to the participant device, wherein the pointer down event activates a drawing property of the inking action.

Example 14 includes the subject matter of any of Examples 10-13, and further specifies that the begin inking event message is associated with a unique inking event identifier, and wherein the stream of coordinate update events is associated with the unique inking event identifier.

Example 15 includes the subject matter of any of Examples 10-14, and further specifies that the method further comprises: receiving, from a second remote inking device, a second begin inking event message for the online meeting; receiving, from the second remote inking device, a second stream of coordinate update events for performing a second inking action, and wherein the second stream of coordinate update events represents physical movement of the second remote inking device as indicated by a physical orientation sensor of the second remote inking device; and for each of the plurality of participant devices: relaying the second begin inking event message to the participant device; and relaying the second stream of coordinate update events to the participant device; wherein the relayed second stream of coordinate update events is usable at the participant device to perform the second inking action on a local display of the participant device; wherein the first inking action is associated with a first unique inking event identifier and the second inking action is associated with a second unique inking event identifier which allows simultaneous display of both the inking action and the second inking action on the local displays of the plurality of participant devices.

Example 16 is one or more computer-readable storage media storing computer-executable instructions for execution on a computing device to perform operations for managing inking events during an online meeting, wherein inking events are events controlling digital inking activity during the online meeting, wherein the online meeting has a plurality of participant devices, and wherein shared screen content is being presented during the online meeting, the operations comprising: receiving, from a remote inking device, a begin inking event message for the online meeting, wherein the remote inking device operates as a virtual laser pointer device during the online meeting; receiving, from the remote inking device, a stream of coordinate update events for performing an inking action, wherein the inking action draws digital ink on the shared screen content, wherein the stream of coordinate update events represents physical movement of the remote inking device as indicated by a gyroscope of the remote inking device, and wherein the inking action is a virtual laser pointer; and for each of the plurality of participant devices: relaying the begin inking event message to the participant device; and relaying the stream of coordinate update events to the participant device; wherein the relayed stream of coordinate update events is usable at the participant device to perform the inking action on a local display of the participant device.

Example 17 includes the subject matter of Example 16, and further specifies that the begin inking event message comprises an indication of an inking tool type, wherein the inking tool type supports a plurality of different inking tools, and wherein the inking action is performed using the inking tool type.

Example 18 includes the subject matter of any of Examples 16-17, and further specifies that the begin inking event message is associated with a unique inking event identifier, and wherein the stream of coordinate update events is associated with the unique inking event identifier.

Example 19 includes the subject matter of any of Examples 16-18, and further specifies that the operations further comprise: receiving, from the remote inking device, a pointer down event; and for each of the plurality of participant devices: relaying the pointer down event to the participant device, wherein the pointer down event initiates display of the virtual laser pointer.

Example 20 includes the subject matter of any of Examples 16-19, and further specifies that the operations further comprise: receiving, from a second remote inking device, a second begin inking event message for the online meeting; receiving, from the second remote inking device, a second stream of coordinate update events for performing a second inking action, and wherein the second stream of coordinate update events represents physical movement of the second remote inking device as indicated by a gyroscope of the second remote inking device; and for each of the plurality of participant devices: relaying the second begin inking event message to the participant device; and relaying the second stream of coordinate update events to the participant device; wherein the relayed second stream of coordinate update events is usable at the participant device to perform the inking action on a local display of the participant device; wherein the first inking action is associated with a first unique inking event identifier and the second inking action is associated with a second unique inking event identifier which allows simultaneous display of both the inking action and the second inking action on the local displays of the plurality of participant devices.

### Computing Systems

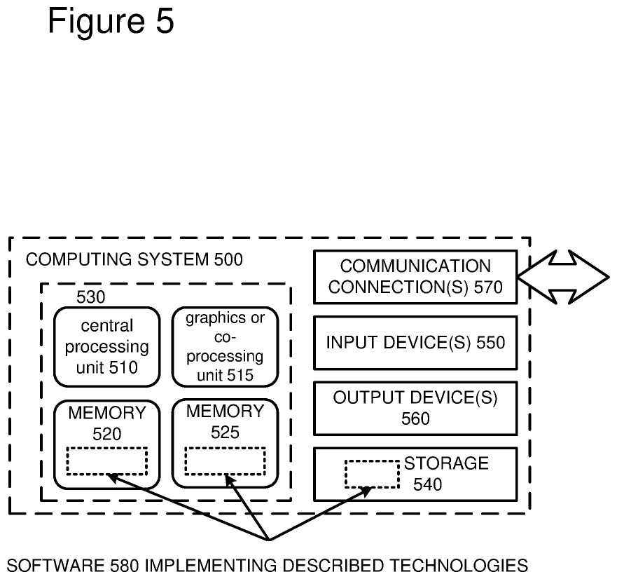

FIG. 5 depicts a generalized example of a suitable computing system 500 in which the described technologies may be implemented. The computing system 500 is not intended to suggest any limitation as to scope of use or functionality, as the technologies may be implemented in diverse general-purpose or special-purpose computing systems.

With reference to FIG. 5, the computing system 500 includes one or more processing units 510, 515 and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC), or any other type of processor.

A processing unit can also comprise multiple processors. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), non-volatile memory (e.g., ROM, EEPROM, flash memory, etc.), or some combination of the two, accessible by the processing unit(s). The memory 520, 525 stores software 580 implementing one or more technologies described herein, in the form of computer-executable instructions suitable for execution by the processing unit(s).

A computing system may have additional features. For example, the computing system 500 includes storage 540, one or more input devices 550, one or more output devices 560, and one or more communication connections 570. An interconnection mechanism (not shown) such as a bus, controller, or network interconnects the components of the computing system 500. Typically, operating system software (not shown) provides an operating environment for other software executing in the computing system 500, and coordinates activities of the components of the computing system 500.

The tangible storage 540 may be removable or non-removable, and includes magnetic disks, magnetic tapes or cassettes, CD-ROMs, DVDs, or any other medium which can be used to store information and which can be accessed within the computing system 500. The storage 540 stores instructions for the software 580 implementing one or more technologies described herein.

The input device(s) 550 may be a touch input device such as a keyboard, mouse, pen, or trackball, a voice input device, a scanning device, or another device that provides input to the computing system 500. For video encoding, the input device(s) 550 may be a camera, video card, TV tuner card, or similar device that accepts video input in analog or digital form, or a CD-ROM or CD-RW that reads video samples into the computing system 500. The output device(s) 560 may be a display, printer, speaker, CD-writer, or another device that provides output from the computing system 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The technologies can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud-Supported Environment

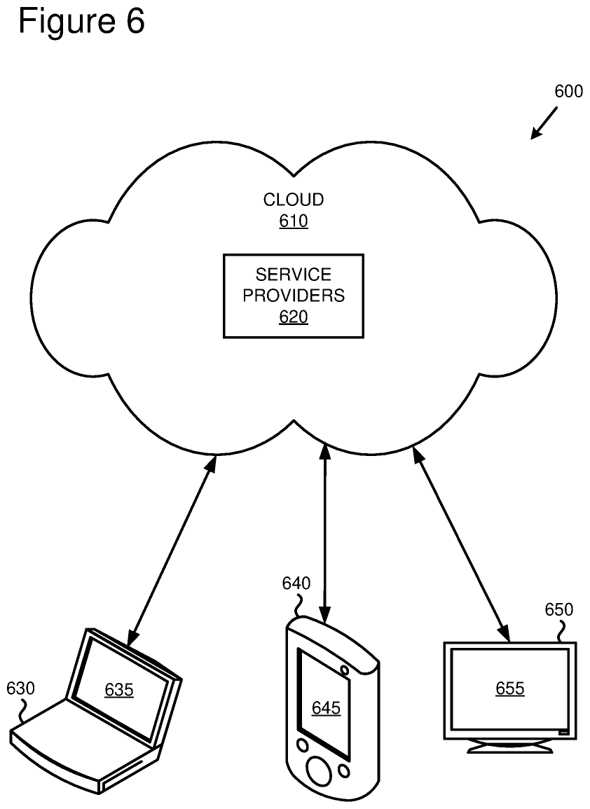

FIG. 6 illustrates a generalized example of a suitable cloud-supported environment 600 in which described embodiments, techniques, and technologies may be implemented. In the example environment 600, various types of services (e.g., computing services) are provided by a cloud 610. For example, the cloud 610 can comprise a collection of computing devices, which may be located centrally or distributed, that provide cloud-based services to various types of users and devices connected via a network such as the Internet. The implementation environment 600 can be used in different ways to accomplish computing tasks. For example, some tasks (e.g., processing user input and presenting a user interface) can be performed on local computing devices (e.g., connected devices 630, 640, 650) while other tasks (e.g., storage of data to be used in subsequent processing) can be performed in the cloud 610.

In example environment 600, the cloud 610 provides services for connected devices 630, 640, 650 with a variety of screen capabilities. Connected device 630 represents a device with a computer screen 635 (e.g., a mid-size screen). For example, connected device 630 could be a personal computer such as desktop computer, laptop, notebook, netbook, or the like. Connected device 640 represents a device with a mobile device screen 645 (e.g., a small size screen). For example, connected device 640 could be a mobile phone, smart phone, personal digital assistant, tablet computer, and the like. Connected device 650 represents a device with a large screen 655. For example, connected device 650 could be a television screen (e.g., a smart television) or another device connected to a television (e.g., a set-top box or gaming console) or the like. One or more of the connected devices 630, 640, 650 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 600. For example, the cloud 610 can provide services for one or more computers (e.g., server computers) without displays.

Services can be provided by the cloud 610 through service providers 620, or through other providers of online services (not depicted). For example, cloud services can be customized to the screen size, display capability, and/or touchscreen capability of a particular connected device (e.g., connected devices 630, 640, 650).

In example environment 600, the cloud 610 provides the technologies and solutions described herein to the various connected devices 630, 640, 650 using, at least in part, the service providers 620. For example, the service providers 620 can provide a centralized solution for various cloud-based services. The service providers 620 can manage service subscriptions for users and/or devices (e.g., for the connected devices 630, 640, 650 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 5, computer-readable storage media include memory 520 and 525, and storage 540. The term computer-readable storage media does not include signals and carrier waves. In addition, the term computer-readable storage media does not include communication connections, such as 570.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A computing device configured to operate as an online meeting service and perform operations for managing inking events during an online meeting, wherein inking events are events controlling digital inking activity during the online meeting, wherein the online meeting has a plurality of participant devices, and wherein shared screen content is being presented during the online meeting, the computing device comprising:
a processor;
a network interface; and
memory;
the computing device configured to perform operations for managing the inking events during the online meeting, the operations comprising:
receiving an indication that a mobile computing device has joined the online meeting as a remote inking device;
receiving, from the remote inking device, a stream of coordinate update events for performing an inking action during the online meeting, wherein the inking action draws digital ink on the shared screen content, and wherein the stream of coordinate update events represents physical movement of the remote inking device as indicated by a physical orientation sensor of the remote inking device; and
for each of the plurality of participant devices:
relaying the stream of coordinate update events to the participant device;
wherein the relayed stream of coordinate update events is usable at the participant device to perform the inking action on a local display of the participant device.

2. The computing device of claim 1, the operations further comprising:
prior to receiving the stream of coordinate update events, receiving, from the remote inking device, a begin inking event message, wherein the begin inking event message comprises an indication of an inking tool type, and wherein the inking action is performed using the inking tool type.

3. The computing device of claim 2, wherein the remote inking device operates as a virtual laser pointer device, and wherein the inking tool type is a virtual laser pointer.

4. The computing device of claim 2, wherein the inking tool type supports a plurality of different inking tools, comprising a virtual laser pointer, a line drawing tool, and a highlighter tool.

5. The computing device of claim 1, wherein the physical orientation sensor comprises a gyroscope, and wherein the stream of coordinate update events comprises x and y coordinate values that are translated from yaw and pitch data obtained from the gyroscope of the remote inking device.

6. The computing device of claim 1, the operations further comprising:
receiving, from the remote inking device, a pointer down event; and
for each of the plurality of participant devices:
relaying the pointer down event to the participant device, wherein the pointer down event activates a drawing property of the inking action.

7. The computing device of claim 1, wherein receiving the indication that the mobile computing device has joined the online meeting as a remote inking device comprises:
receiving, from the remote inking device, a begin inking event message;
wherein the begin inking event message is associated with a unique inking event identifier, and wherein the stream of coordinate update events is associated with the unique inking event identifier.

8. The computing device of claim 1, the operations further comprising:
receiving, from a second remote inking device, a second stream of coordinate update events for performing a second inking action, and wherein the second stream of coordinate update events represents physical movement of the second remote inking device as indicated by a physical orientation sensor of the second remote inking device; and
for each of the plurality of participant devices:
relaying the second stream of coordinate update events to the participant device;
wherein the relayed second stream of coordinate update events is usable at the participant device to perform the second inking action on a local display of the participant device;
wherein the first inking action is associated with a first unique inking event identifier and the second inking action is associated with a second unique inking event identifier which allows simultaneous display of both the inking action and the second inking action on the local displays of the plurality of participant devices.

9. The computing device of claim 1, the operations further comprising:
receiving, from a participant device presenting the shared screen content, an indication of workspace dimensions of the shared screen content; and
sending, to the remote inking device, the indication of the workspace dimensions of the shared screen content, wherein the indication of the workspace dimensions of the shared screen content is usable by the remote inking device to establish a boundary for the stream of coordinate update events.

10. A method, implemented by a computing device, for managing inking events during an online meeting, wherein inking events are events controlling digital inking activity during the online meeting, wherein the online meeting has a plurality of participant devices, and wherein shared screen content is being presented during the online meeting, the method comprising:
receiving, from a remote inking device, a begin inking event message for the online meeting;
receiving, from the remote inking device, a stream of coordinate update events for performing an inking action, wherein the inking action draws digital ink on the shared screen content, and wherein the stream of coordinate update events represents physical movement of the remote inking device as indicated by a physical orientation sensor of the remote inking device; and
for each of the plurality of participant devices:
relaying the begin inking event message to the participant device; and
relaying the stream of coordinate update events to the participant device;
wherein the relayed stream of coordinate update events is usable at the participant device to perform the inking action on a local display of the participant device.

11. The method of claim 10, wherein the remote inking device operates as a virtual laser pointer device, wherein the inking action is a virtual laser pointer, and wherein the relayed stream of coordinate update events is usable at each of the plurality of participant devices to display the virtual laser pointer on its respective local display.

12. The method of claim 10, wherein the physical orientation sensor comprises a gyroscope, and wherein the stream of coordinate update events comprises x and y coordinate values that are translated from yaw and pitch data obtained from the gyroscope of the remote inking device.

13. The method of claim 10, further comprising:
receiving, from the remote inking device, a pointer down event; and
for each of the plurality of participant devices:
relaying the pointer down event to the participant device, wherein the pointer down event activates a drawing property of the inking action.

14. The method of claim 10, wherein the begin inking event message is associated with a unique inking event identifier, and wherein the stream of coordinate update events is associated with the unique inking event identifier.

15. The method of claim 10, further comprising:
receiving, from a second remote inking device, a second begin inking event message for the online meeting;
receiving, from the second remote inking device, a second stream of coordinate update events for performing a second inking action, and wherein the second stream of coordinate update events represents physical movement of the second remote inking device as indicated by a physical orientation sensor of the second remote inking device; and
for each of the plurality of participant devices:
relaying the second begin inking event message to the participant device; and
relaying the second stream of coordinate update events to the participant device;
wherein the relayed second stream of coordinate update events is usable at the participant device to perform the second inking action on a local display of the participant device;
wherein the first inking action is associated with a first unique inking event identifier and the second inking action is associated with a second unique inking event identifier which allows simultaneous display of both the inking action and the second inking action on the local displays of the plurality of participant devices.

16. One or more computer-readable storage media storing computer-executable instructions for execution on a computing device to perform operations for managing inking events during an online meeting, wherein inking events are events controlling digital inking activity during the online meeting, wherein the online meeting has a plurality of participant devices, and wherein shared screen content is being presented during the online meeting, the operations comprising:
receiving, from a remote inking device, a begin inking event message for the online meeting, wherein the remote inking device operates as a virtual laser pointer device during the online meeting;
receiving, from the remote inking device, a stream of coordinate update events for performing an inking action, wherein the inking action draws digital ink on the shared screen content, wherein the stream of coordinate update events represents physical movement of the remote inking device as indicated by a gyroscope of the remote inking device, and wherein the inking action is a virtual laser pointer; and
for each of the plurality of participant devices:
relaying the begin inking event message to the participant device; and
relaying the stream of coordinate update events to the participant device;
wherein the relayed stream of coordinate update events is usable at the participant device to perform the inking action on a local display of the participant device.

17. The one or more computer-readable storage media of claim 16, wherein the begin inking event message comprises an indication of an inking tool type, wherein the inking tool type supports a plurality of different inking tools, and wherein the inking action is performed using the inking tool type.

18. The one or more computer-readable storage media of claim 16, wherein the begin inking event message is associated with a unique inking event identifier, and wherein the stream of coordinate update events is associated with the unique inking event identifier.

19. The one or more computer-readable storage media of claim 16, the operations further comprising:
receiving, from the remote inking device, a pointer down event; and
for each of the plurality of participant devices:
relaying the pointer down event to the participant device, wherein the pointer down event initiates display of the virtual laser pointer.

20. The one or more computer-readable storage media of claim 16, the operations further comprising:
receiving, from a second remote inking device, a second begin inking event message for the online meeting;
receiving, from the second remote inking device, a second stream of coordinate update events for performing a second inking action, and wherein the second stream of coordinate update events represents physical movement of the second remote inking device as indicated by a gyroscope of the second remote inking device; and
for each of the plurality of participant devices:
relaying the second begin inking event message to the participant device; and
relaying the second stream of coordinate update events to the participant device;
wherein the relayed second stream of coordinate update events is usable at the participant device to perform the inking action on a local display of the participant device;
wherein the first inking action is associated with a first unique inking event identifier and the second inking action is associated with a second unique inking event identifier which allows simultaneous display of both the inking action and the second inking action on the local displays of the plurality of participant devices.
